(19) United States
(12) Patent Application Publication
(10) Pub. No.: US 2014/0175935 A1
(43) Pub. Date: Jun. 26, 2014

(54) ROTARY ELECTRIC MACHINE

(71) Applicant: Toyota Jidosha Kabushiki Kaisha, Toyota-shi (JP)

(72) Inventors: Yukio TSUCHIYA, Toyota-shi (JP); Hiroshi KAWANO, Nagoya-shi (JP); Yuki YAMAKAWA, Toyoake-shi (JP)

(73) Assignee: TOYOTA JIDOSHA KABUSHIKI KAISHA, Toyota-shi (JP)

(21) Appl. No.: 14/108,658

(22) Filed: Dec. 17, 2013

(30) Foreign Application Priority Data
Dec. 26, 2012 (JP) 2012-282845

(51) Int. Cl. H02K 3/46

(52) U.S. Cl. CPC H02K 3/46
USPC 310/214

(57) ABSTRACT

A motor-generator that is a rotary electric machine includes a cylindrical stator core having a plurality of teeth that are arranged spaced apart from each other in a circumferential direction and extend in a radial direction; a cassette coil arranged on an outer periphery of each of the teeth; an insulator that has a pawl portion and is interposed between the stator core and the cassette coil; and a wedge that is provided extending between the cassette coils that are adjacent to each other, which fixes the cassette coils with respect to the stator core. The wedge is retained by the pawl portions of the insulators that are adjacent to each other.

### INCORPORATION BY REFERENCE

The disclosure of Japanese Patent Application No. 2012-282845 filed on Dec. 26, 2012 including the specification, drawings and abstract is incorporated herein by reference in its entirety.

### BACKGROUND OF THE INVENTION

1. Field of the Invention

The invention relates to a rotary electric machine, and more particularly, to a rotary electric machine provided with a concentrated winding cassette coil type stator.

2. Description of Related Art

With regards to a rotary electric machine according to related art, Japanese Patent Application Publication No. 9-84287 (JP 9-84287 A) describes a stator of a rotary electric machine that aims to improve a space factor (winding density) of an excitation winding, and a manufacturing method thereof. The stator of the rotary electric machine described in JP 9-84287 A includes a stator core provided with eight pole teeth at equidistant intervals on an inner peripheral surface, and an exciting coil inserted between the pole teeth. A notch is formed near a tip end of each pole tooth. A retaining member formed in a plate shape with insulating material such as resin is attached between the notches of adjacent pole teeth.

Also, Japanese Patent Application Publication No. 2009-189145 (JP 2009-189145 A) Japanese Patent Application Publication No. 2002-305851 (JP 2002-305851 A), Japanese Patent Application Publication No. 2001-8395 (JP 2001-8395 A), and Published Japanese Translation of PCT application No. 2009-528811 (JP-A-2009-528811) all describe various rotary electric machines (electric motors).

With the electric motor described in JP 9-84287 A described above, the retaining member for preventing the exciting coil from slipping off of the pole teeth (teeth) is attached to the notches formed in the pole teeth. However, when notches are formed in the pole teeth in this way, the sectional area of a path along which magnetic flux flows (i.e., a magnetic path) becomes locally smaller, so torque generated by the electric motor may decrease.

Also, some other conceivable methods for fixing the coil are adhesion with varnish, and resin molding. However, with the former method, there may be uneven adhesion due to the varnish not spreading over the entire coil, and with the latter method, cracking may occur in the molded resin after it hardens. In these cases, it is difficult to sufficiently increase the reliability with which the coil is fixed.

### SUMMARY OF THE INVENTION

The invention aims to provide a rotary electric machine that inhibits a decrease in torque, and in which the coil is able to be fixed with high reliability.

A first aspect of the invention relates to a rotary electric machine that includes a cylindrical stator core having a plurality of teeth that are arranged spaced apart from each other in a circumferential direction and extend in a radial direction; a cassette coil arranged on an outer periphery of each of the teeth; an insulator that has a retaining portion and is interposed between the stator core and the cassette coil; and a fixing member that is provided extending between the cassette coils that are adjacent to each other, which fixes the cassette coils with respect to the stator core. The fixing member is retained by the retaining portions of the insulators that are adjacent to each other.

According to the rotary electric machine of the first aspect, the fixing member is retained by the retaining portions of the insulators, so a torque decrease of the rotary electric machine is able to be inhibited. Also, the fixing member is retained by the retaining portions of the insulators that area adjacent to each other, so the fixing member is able to be more reliably retained. As a result, the reliability with which the cassette coil is fixed by the fixing member is able to be sufficiently increased.

Also, when tip ends of the teeth that extend in the radial direction of the stator core are viewed from an outside in the redial direction of the stator core, the retaining portion may be positioned in an area to an inside of the cassette coil. With a rotary electric machine structured in this way, workability during assembly of the cassette coils is able to be improved.

Also, the cassette coil may have a coil end portion positioned on an end surface of the stator core. The fixing member may be retained by the retaining portion in a position facing the coil end portion. With a rotary electric machine structured in this way, it is possible to more reliably inhibit the cassette coil from coming out of position due to the repulsion force (spring back force) of the cassette coil.

Also, the cassette coil may be formed by a flat wire multi-layered winding coil. With a rotary electric machine structured in this way, it is possible to improve the reliability with which the coil is fixed, while inhibiting a torque decrease, in a rotary electric machine that uses a flat wire multi-layered winding coil as the cassette coil.

Also, the fixing member may include a pressing portion that extends between the cassette coils that are adjacent to each other and extends in an axial direction of the stator core while abutting against the cassette coils, and an engaging portion that is provided on an end portion of the pressing portion in an extending direction thereof, and is engaged by the retaining portion. With a rotary electric machine structured in this way, it is possible to retain the fixing member by the engaging portion of the fixing member being engaged by the retaining portion of the insulator.

Also, the retaining portion may have a pawl shape that is arranged farther toward a radially inward side of the stator core than the cassette coil, and the engaging portion may be inserted between the cassette coil and the retaining portion. With a rotary electric machine structured in this way, it is possible to retain the fixing member by the engaging portion being inserted between the cassette coil and the retaining portion.

According to the rotary electric machine of the first aspect, a decrease in torque is able to be inhibited, and the coil is able to be fixed with high reliability.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view showing a frame format of a vehicle drive unit;

FIG. 2 is a perspective view of a stator that forms part of a motor-generator according to one example embodiment of the invention;

FIG. 3 is a sectional view of part of the stator shown in FIG. 2;

FIG. 4 is a perspective view of an anti-lead side of the stator in FIG. 2, viewed from an inner peripheral side;

FIG. 5 is a perspective view of an insulator provided on the stator in FIG. 2;

FIG. 6 is a perspective view of a wedge provided on the stator in FIG. 2;

FIG. 7 is another perspective view of the wedge provided on the stator in FIG. 2;

FIG. 8 is a perspective view of a process during assembly of the stator in FIG. 2;

FIG. 9 is a perspective view of a lead-side of the stator in FIG. 2, viewed from the inner peripheral side;

FIG. 10 is a view showing a frame format of the stator viewed from a direction indicated by arrow X in FIG. 4; and

FIG. 11 is a sectional view of the stator taken along line XI-XI in FIG. 10.

### DETAILED DESCRIPTION OF EMBODIMENTS

Example embodiments of the invention will now be described with reference to the accompanying drawings. In the drawings referred to below, like or corresponding members will be referred to by like reference characters.

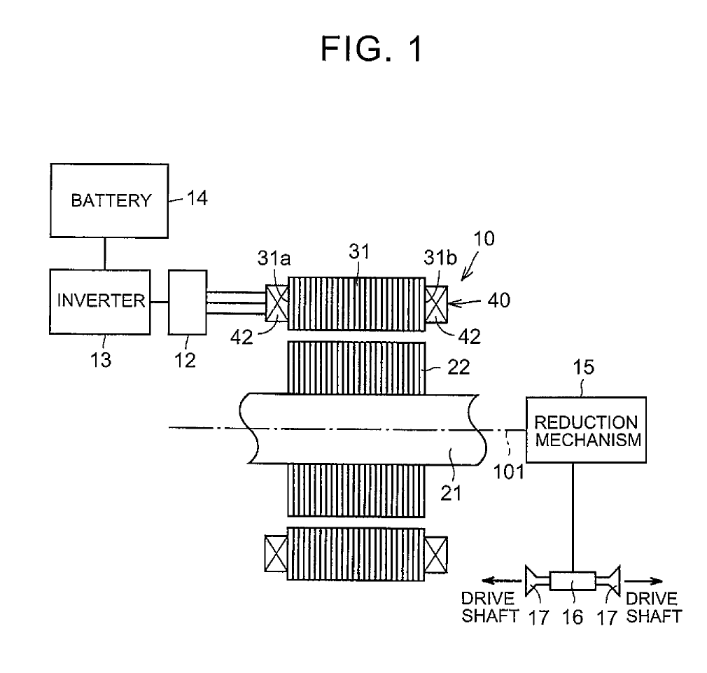

FIG. 1 is a sectional view showing a frame format of a vehicle drive unit. The vehicle drive unit shown in the drawing is provided in a hybrid vehicle that uses an internal combustion engine such as a gasoline engine or a diesel engine, and an electric motor that receives a supply of electric power from a secondary battery (i.e., a battery) capable of charging and discharging, as power sources.

Referring to FIG. 1, the vehicle drive unit has a motor-generator 10. This motor-generator 10 is a rotary electric machine that functions as an electric motor or a generator, according to the running state of the hybrid vehicle. First, the basic structures of the motor-generator 10 of the example embodiment, and the vehicle drive unit that is equipped with the motor-generator 10, will be described.

The motor-generator 10 has a rotor shaft 21, a rotor core 22, and a stator core 31 as component parts. The rotor core 22 is integrated with the rotor shaft 21, and rotates around a center axis 101 that is a virtual axis. That is, the center axis 101 is a rotational axis of the motor-generator 10. The stator core 31 is arranged on an outer periphery of the rotor core 22.

The rotor shaft 21 extends in an axial direction of the center axis 101. The rotor shaft 21 is rotatably supported with respect to a motor case, not shown, via bearings provided spaced apart in the axial direction of the center axis 101. The rotor shaft 21 is connected to a reduction mechanism 15 that includes a plurality of gears.

The rotor core 22 has a shape that extends in a cylindrical shape in the axial direction of the center axis 101. The rotor core 22 is made from a plurality of magnetic steel sheets stacked together in the axial direction of the center axis 101. The magnetic steel sheets have a flat disc-like shape that extends in a plane orthogonal to the center axis 101. Permanent magnets, not shown, are embedded in the rotor core 22.

The stator core 31 has a shape that extends in a cylindrical shape in the axial direction of the center axis 101. The stator core 31 is made from a plurality of magnetic steel sheets stacked together in the axial direction of the center axis 101. The stator core 31 has an end surface 31a that faces one end side in the direction in which the center axis 101 extends, and an end surface 31b that faces the other end side in which the center axis 101 extends.

The motor-generator 10 also has a three-phase coil 40 as a component part. The three-phase coil 40 is wound around the stator core 31. The three-phase coil 40 has a coil end portion 42. The coil end portion 42 is provided in a position protruding in the axial direction of the center axis 101 from the end surface 31a and the end surface 31b of the stator core 31. The coil end portion 42 is provided in a manner circularly revolving around the center axis 101.

The three-phase coil 40 includes a U-phase coil, a V-phase coil, and a W-phase coil. Terminals corresponding to these phase coils are connected to a terminal block 12. The terminal block 12 is electrically connected to a battery 14 via an inverter 13. The inverter 13 converts direct current from the battery 14 into alternating current for driving an electric motor, as well as converts alternating current generated by regenerative braking into direct current for charging the battery 14.

In this example embodiment, a rotor of the motor-generator 10 is formed by the rotor shaft 21, the rotor core 22, and the permanent magnets, not shown, and a stator of the motor-generator 10 is formed by the stator core 31 and the three-phase coil 40.

Power output from the motor-generator 10 is transmitted from the reduction mechanism 15 to drive shaft receiving portions 17 via a differential mechanism 16. The power transmitted to the drive shaft receiving portions 17 is then transmitted as rotating force to wheels, not shown, via drive shafts.

Meanwhile, during regenerative braking of the hybrid vehicle, the wheels ate rotated by the inertia force of the vehicle body. The motor-generator 10 is driven by the rotating force from the wheels, via the drive shaft receiving portions 17, the differential mechanism 16, and the reduction mechanism 15. At this time, the motor-generator 10 operates as a generator. Electric power generated by the motor-generator 10 is stored in the battery 14 via the inverter 13.

The structure of the stator that forms part of the motor-generator 10 shown in FIG. 1 will now be described in detail.

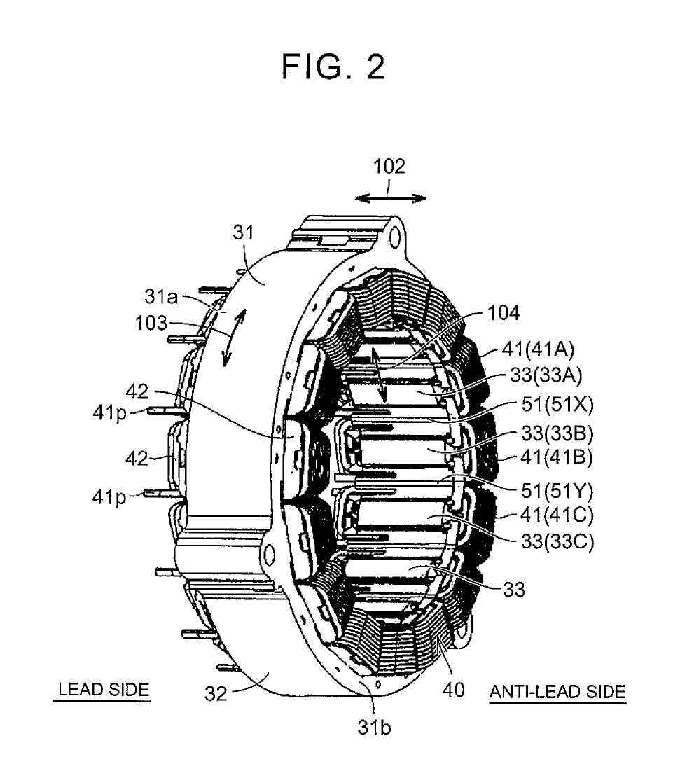

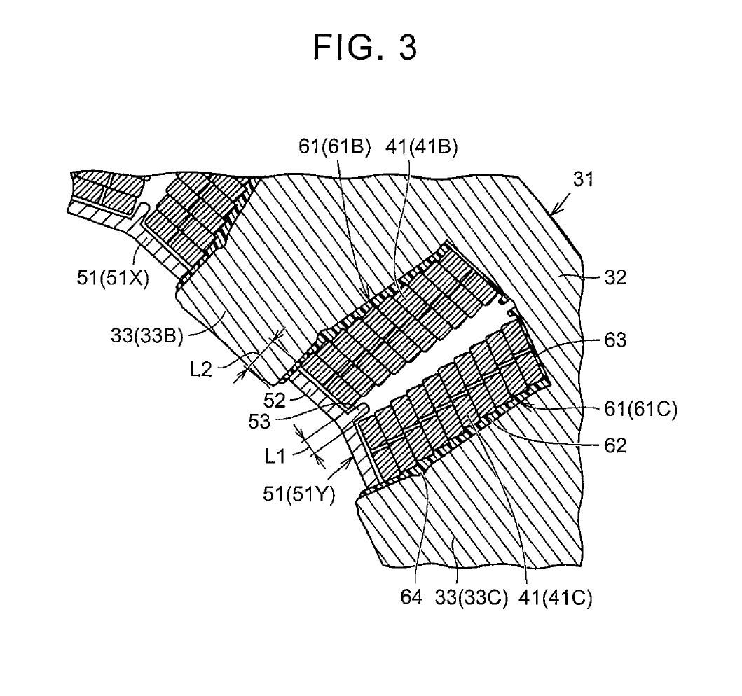

FIG. 2 is a perspective view of the stator that forms part of the motor-generator according to this example embodiment of the invention. FIG. 3 is a perspective view of part of the stator shown in FIG. 2. FIG. 3 shows part of a cross section of the stator in FIG. 2 when the stator is cut along a plane orthogonal to the center axis 101 in FIG. 1.

Referring to FIGS. 2 and 3, the stator core 31 has a cylindrical shape. The stator core 31 has a cylindrical shape overall. The stator core 31 has a cylindrical shape, with the center axis 101 as the center, the direction indicated by arrow 102 in FIG. 2 being the axial direction, the direction indicated by arrow 103 in FIG. 2 being the circumferential direction, and the direction indicated by arrow 104 in FIG. 2 being the radial direction.

The stator core 31 has an annular portion (a yoke) 32 and a plurality of teeth 33, as component parts. The annular portion 32 has a shape that circularly extends around the center axis 101. The teeth 33 are provided spaced apart from each other in the circumferential direction of the stator core 31. The plurality of teeth 33 are provided at equidistant intervals from each other. The teeth 33 are provided extending in the radial direction of the stator core 31. The teeth 33 are provided protruding from the inner peripheral surface of the annular portion 32 toward the radial inside of the stator core 31.

The teeth 33 have a generally rectangular cross-sectional shape when cut along a plane orthogonal to the radial direction of the stator core 31. When cut along a plane orthogonal to the axial direction of the stator core 31, the teeth 33 have a tapered shape in which a length in the circumferential direction of the stator core 31 (i.e., the width of the teeth 33) becomes smaller toward the radial inside of the stator core 31 in an outer peripheral-side region near the annular portion 32, and the teeth 33 have a shape in which the width of the teeth 33 is substantially constant in the radial direction of the stator core 31 in an inner peripheral-side region far from the annular portion 32.

The three-phase coil 40 is formed by a plurality of cassette coils 41 being connected together. The cassette coils 41 are concentrated winding type cassette coils, and the cassette coil 41 are inserted into each of the plurality of teeth 33. As shown in FIG. 3, a correlation distance L1 is ensured between adjacent cassette coils 41, and a tip end gap L2 is ensured between the tip end of each of the teeth 33 and the inner peripheral end of each of the cassette coils 41.

The cassette coils 41 are formed by a flat wire multi-layered winding coils (in this example embodiment, a flat wire two-layered winding coils). More specifically, a flat wire having a rectangular-shaped cross-section is wound in a coil shape along in the radial direction of the stator core 31 on the outer periphery of the teeth 33 such that the short sides of the flat wire face the teeth 33, and is then made into the multi-layered winding by the flat wire being stacked for several levels on the outer periphery of the teeth 33.

The plurality of cassette coils 41 are provided such that both end portions 41p of the flat wire that forms each cassette coil 41 are lined up in the same direction in the axial direction of the stator core 31. The three-phase coil 40 is formed by connecting both end portions 41p of this flat wire using a bus bar. In this example embodiment, the side where the plurality of cassette coils 41 are connected together (i.e., the left side in FIG. 2) will be referred to as the lead-side of the stator core 31, and the opposite side in the axial direction of the stator core 31 will be referred to as the anti-lead side of the stator core 31.

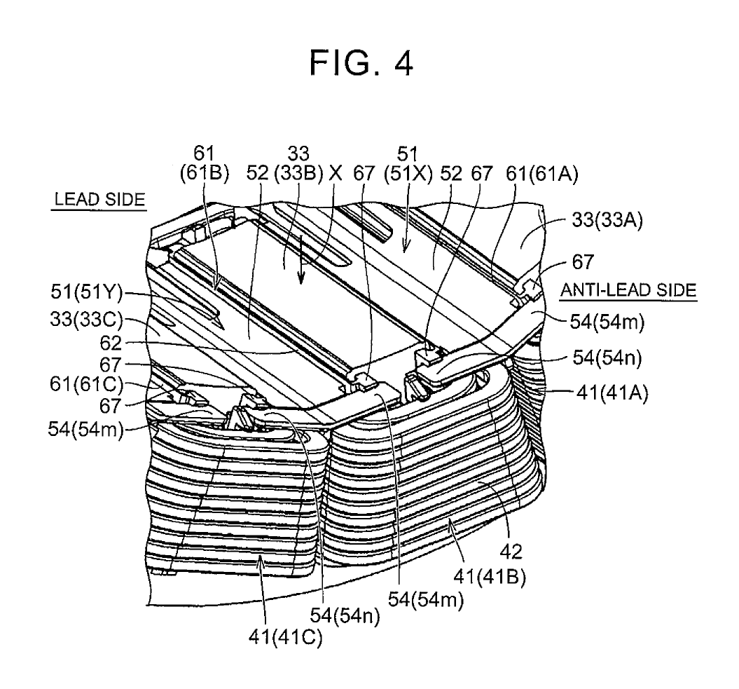

FIG. 4 is a perspective view of the anti-lead side of the stator in FIG. 2, viewed from the inner peripheral side. Referring to FIGS. 2 to 4, the motor-generator 10 in this example embodiment also includes wedges 51 and insulators 61.

The insulators 61 are interposed between the stator core 31 and the cassette coils 41. The insulator 61 has a cylindrical shape overall, and is inserted into the tooth 33. The wedges 51 fix the cassette coils 41 to the stator core 31. The wedges 51 are provided extending between adjacent cassette coils 41 in the circumferential direction of the stator core 31.

To facilitate understanding of the description, three teeth, i.e., tooth 33A, tooth 33B, and tooth 33C, arbitrarily selected from among the plurality of teeth 33, will be assumed. The tooth 33A, the tooth 33B, and the tooth 33C are lined up in order in the circumferential direction of the stator core 31.

In this case, an insulator 61A, an insulator 61B, and an insulator 61C are inserted on the outer periphery of the tooth 33A, the tooth 33B, and the tooth 33C, respectively. Furthermore, a cassette coil 41A, a cassette coil 41B, and a cassette coil 41C are inserted on the outer periphery of the insulator 61A, the insulator 61B, and the insulator 61C, respectively. A wedge 51X is provided extending between the cassette coil 41A and the cassette coil 41B. The wedge 51X fixes the cassette coil 41A and the cassette coil 41B to the stator core 31. A wedge 51Y is provided extending between the cassette coil 41B and the cassette coil 41C. The wedge 51Y fixes the cassette coil 41B and the cassette coil 41C with respect to the stator core 31.

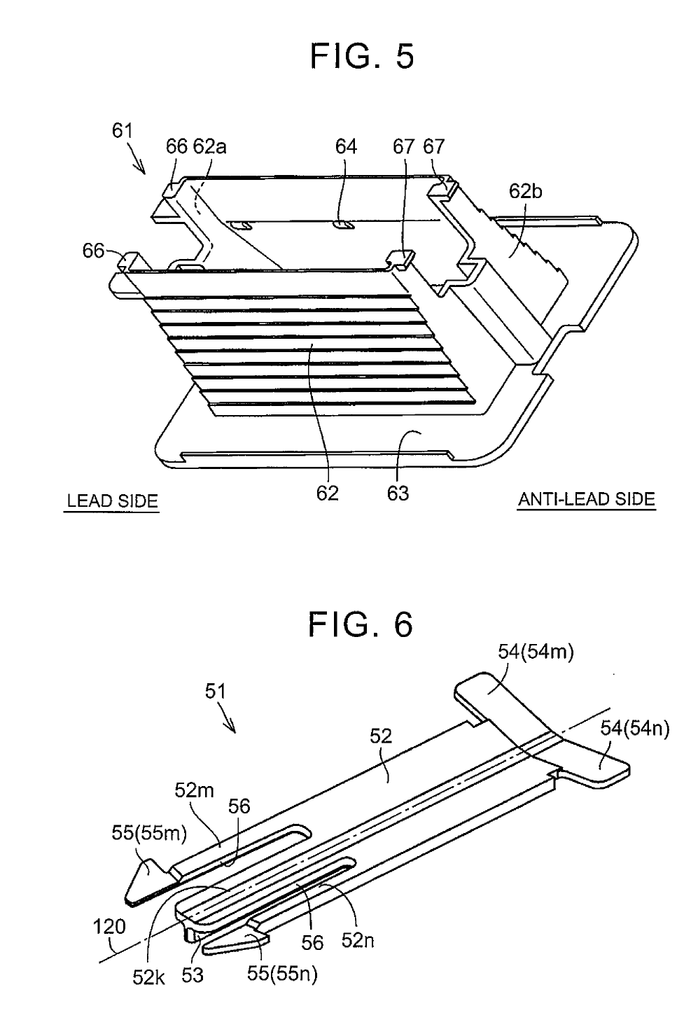

FIG. 5 is a perspective view of one of the insulators provided on the stator in FIG. 2. Referring to FIGS. 3 to 5, the insulator 61 is made of insulating material. The insulator 61 is formed of resin material such as polyethylene terephthalate resin (PET resin), for example. The insulator 61 has a main body portion 62, a flange portion 63, a pawl portion 66, and a pawl portion 67, as component parts.

The main body portion 62 has a shape that matches the teeth 33, and in this example embodiment, the main body portion 62 has a generally cuboid shape with two opposing faces being open. The main body portion 62 is arranged on the outer periphery of each tooth 33. The main body portion 62 is interposed between the tooth 33 and the cassette coil 41. The main body portion 62 has a side surface 62a and a side surface 62b. The side surface 62a is arranged on the lead side of the stator core 31, and the side surface 62b is arranged on the anti-lead side of the stator core 31. A protruding portion 64 is formed on an inner peripheral surface of the main body portion 62. The insulator 61 is fixed to the tooth 33 by the protruding portion 64 fitting into a recessed portion formed on an outer peripheral surface of the tooth 33.

The flange portion 63 is provided flared out in a flange shape from one open side end portion (an outer peripheral side end portion) of the main body portion 62. The flange portion 63 is interposed between the cassette coil 41 and the annular portion 32 of the stator core 31, at a base portion of the tooth 33.

The pawl portion 66 is provided on the other open side end portion (i.e., an inner peripheral side end portion) of the main body portion 62. The pawl portion 66 has a pawl shape that is bent over from the side surface 62a toward the outside of the main body portion 62. The pawl portion 66 is provided in two locations separated from each other in the circumferential direction of the stator core 31. The pawl portion 66 is provided farther to the inner peripheral side than the cassette coil 41, in the radial direction of the stator core 31.

The pawl portion 67 is provided on the other open side end portion (i.e., an inner peripheral side end portion) of the main body portion 62. The pawl portion 67 is provided on the anti-lead side of the stator core 31. The pawl portion 67 has a shape that is bent over from the side surface 62b toward the outside of the main body portion 62. The pawl portion 67 is provided in two locations separated from each other in the circumferential direction of the stator core 31. The pawl portion 67 is provided farther to the inner peripheral side than the cassette coil 41, in the radial direction of the stator core 31.

The pawl portion 66 is provided on the end surface 31a of the stator core 31. The pawl portion 67 is provided on the end surface 31b of the stator core 31. The pawl portion 66 and the pawl portion 67 are positioned facing the coil end portion 42 of the cassette coil 41, on the lead side and the anti-lead side, respectively, of the stator core 31.

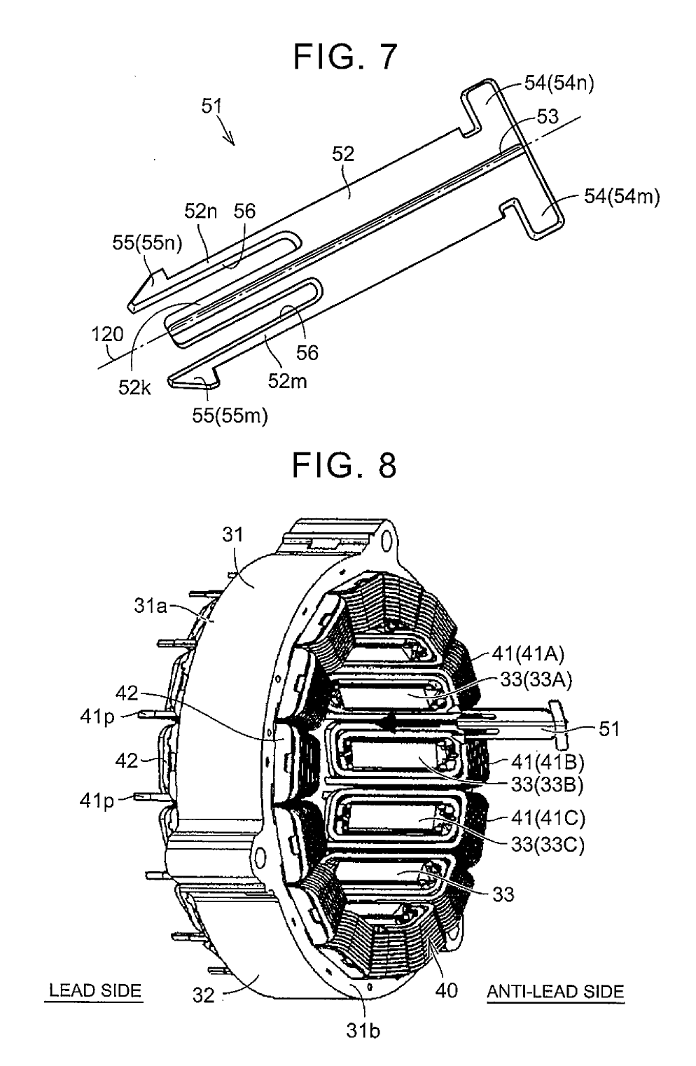

FIGS. 6 and 7 are perspective views of one of the wedges provided on the stator in FIG. 2. Referring to FIGS. 3 to 7, the wedge 51 is made of insulating material such as resin. The wedge 51 has a pressing portion 52 and a rib-like portion 53 as component parts.

The pressing portion 52 extends in the axial direction of the stator core 31. The pressing portion 52 is provided abutting against the cassette coils 41 between adjacent teeth 33. The pressing portion 52 is provided sandwiching the cassette coils 41 between the pressing portion 52 and the annular portion 32 of the stator core 31. The pressing portion 52 applies force to the cassette coils 41 that presses the cassette coils 41 toward the radial outside of the stator core 31.

The pressing portion 52 has a shape that branches off into three at an end portion (the lead side) in the axial direction of the stator core 31.

More specifically, the pressing portion 52 has a branch portion 52m, a branch portion 52k, and a branch portion 52n as component parts. The branch portion 52m and the branch portion 52n are arranged one on either side of the branch portion 52k. The branch portion 52m and the branch portion 52k, as well as the branch portion 52k and the branch portion 52n, are separated by a cutout portion 56 extending in the axial direction of the stator core 31. With this kind of structure, the pressing portion 52 is formed so as to be able to be elastically deformable such that the distance between the branch portion 52m and the branch portion 52n increases and decreases.

The rib-like portion 53 is provided on a front surface on the outer peripheral side of the pressing portion 52. The rib-like portion 53 is provided extending in a rib shape along in the axial direction of the stator core 31. The rib-like portion 53 is provided on the branch portion 52k, on the end portion on the lead side of the stator core 31. The rib-like portion 53 is positioned between adjacent cassette coils 41, as shown in FIG. 3.

The wedge 51 has a protruding portion 54m and a protruding portion 54n (hereinafter, collectively referred to as “protruding portions 54” when there is no need to distinguish between the two), as component parts.

The protruding portions 54 are provided on an end portion of the pressing portion 52, in the extending direction thereof. The protruding portions 54 are provided on the end portion on the anti-lead side of the stator core 31. The protruding portions 54 protrude in the circumferential direction of the stator core 31 from the pressing portion 52.

The protruding portion 54m protrudes toward one side in the circumferential direction of the stator core 31 from the pressing portion 52, and the protruding portion 54n protrudes toward the other side in the circumferential direction of the stator core 31 from the pressing portion 52.

The wedge 51 also has a hooked portion 55m and a hooked portion 55n (hereinafter these will collectively be referred to as “hooked portions 55” when there is no need to distinguish between the two), as component parts.

The hooked portions 55 are provided on an end portion of the pressing portion 52, in the extending direction thereof. The hooked portions 55 are provided on the end portion on the lead side of the stator core 31. The hooked portion 55m and the hooked portion 55n are provided on a tip end of the branch portion 52m and the branch portion 52n, respectively. The hooked portions 55 have a hooked shape that protrudes in the circumferential direction of the stator core 31 from the pressing portion 52. The hooked portion 55m has a hooked shape that protrudes from the branch portion 52m, in a direction away from the branch portion 52n. The hooked portion 55n has a hooked shape that protrudes from the branch portion 52n, in a direction away from the branch portion 52m.

The wedge 51 has a shape that is bent along a center line 120 in the circumferential direction of the stator core 31. The rib-like portion 53 described above extends in a rib shape along the center line 120. The wedge 51 has a symmetrical shape with respect to the center line 120.

FIG. 8 is a perspective view of a process during assembly of the stator in FIG. 2. Referring to FIG. 8, first the cassette coils 41 and the insulators 61 are assembled to the stator core 31. At this time, the insulators 61 may be inserted into the teeth 33 after the cassette coils 41 are inserted into the main body portions 62 of the insulators 61, or the cassette coils 41 may be inserted into the main body portions 62 after the insulators 61 are inserted into the teeth 33.

Next, the wedges 51 are assembled to the stator core 31. At this time, the wedges 51 are inserted from the anti-lead side of the stator core 31. Each of the wedges 51 is inserted between adjacent cassette coils 41, in a position for fixing the stator core 31, while elastically deforming such that the branch portion 52m and the branch portion 52n come close to one another.

When the wedges 51 are assembled before both of the end portions 41p of the flat wire that make up the cassette coils 41 are connected, it is not necessary to consider interference between the wedges 51 and the wire connecting portion from the bus bar, so the wedges 51 are also able to be inserted from the lead side of the stator core 31.

Referring to FIG. 4, when the wedges 51 are assembled to the stator core 31, the protruding portions 54 of the wedges 51 are engaged by the pawl portions 67 of the insulators 61 on both sides of the wedges 51, on the anti-lead side of the stator core 31.

Now the area shown in FIG. 4 will be described in more detail. The protruding portion 54m of the wedge 51X is inserted between the cassette coil 41A and the pawl portion 67 of the insulator 61A, and the protruding portion 54n of the wedge 51X is inserted between the cassette coil 41B and the pawl portion 67 of the insulator 61B. The protruding portion 54m of the wedge 51Y is inserted between the cassette coil 41B and the pawl portion 67 of the insulator 61B, and the protruding portion 54n of the wedge 51Y is inserted between the cassette coil 41C and the pawl portion 67 of the insulator 61C.

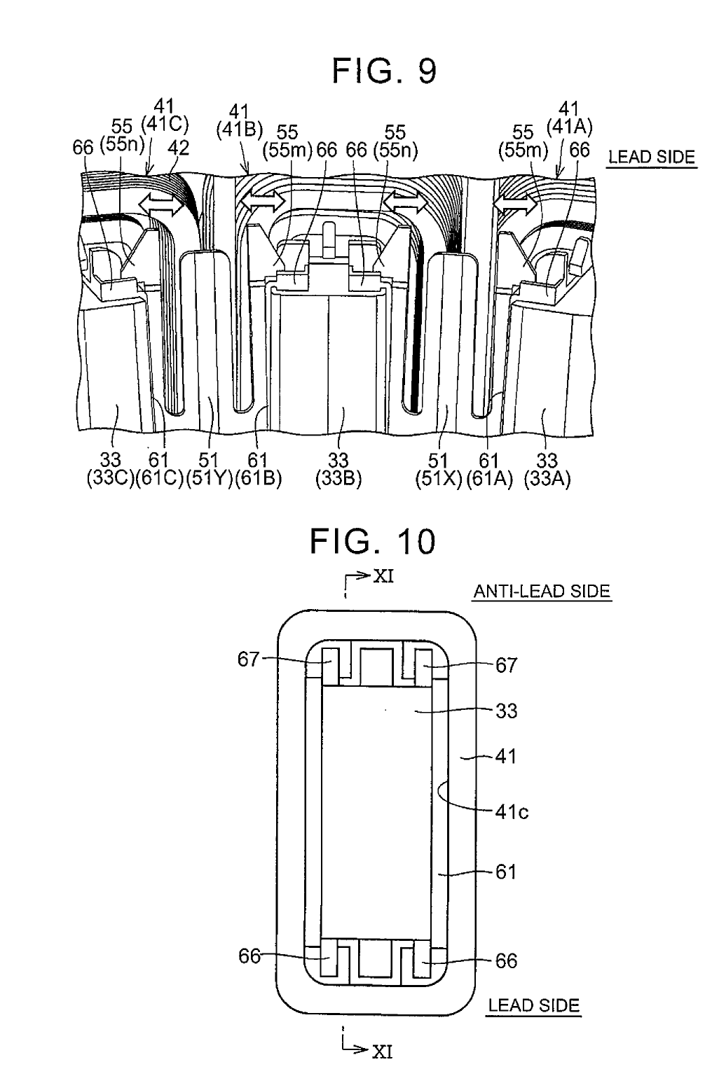

FIG. 9 is a perspective view of the lead side of the stator in FIG. 2, viewed from the inner peripheral side. Referring to FIG. 9, when the wedge 51 is assembled to the stator core 31, the hooked portions 55 of the wedge 51 are engaged by the pawl portions 66 of the insulators 61 on both sides of the wedge 51, on the lead side of the stator core 31.

Now the area shown in FIG. 9 will be described in more detail. The hooked portion 55m of the wedge 51X is inserted between the cassette coil 41A and the pawl portion 66 of the insulator 61A, and the hooked portion 55n of the wedge 51X is inserted between the cassette coil 41B and the pawl portion 66 of the insulator 61B. The hooked portion 55m of the wedge 51Y is inserted between the cassette coil 41B and the pawl portion 66 of the insulator 61B, and the hooked portion 55n of the wedge 51Y is inserted between the cassette coil 41C and the pawl portion 66 of the insulator 61C.

According to this kind of structure, the wedges 51 is retained extending between the pawl portions 67 of adjacent insulators 61 on the anti-lead side of the stator core 31, and retained extending between the pawl portions 66 of adjacent insulators 61 on the lead side of the stator core 31. The insulators 61 serve to prevent the wedges 51 from getting out toward the radial inside of the stator core 31, and restrict the rotation of the wedges 51 in the circumferential direction of the stator core 31.

In the motor-generator 10 of this example embodiment, the wedges 51 are retained by insulators 61 that are adjacent to each other, so the reliability with which the cassette coils 41 are fixed by the wedges 51 is able to be increased.

Also, in this example embodiment, the wedges 51 are retained to the stator core 31, by the insulators 61 that ensure insulation between the stator core 31 and the cassette coils 41. Therefore, a mechanism such as grooves for retaining the wedges 51 no longer needs to be provided in the teeth 33, so the width of the tip end portions of the teeth 33 can be set large. As a result, loss deterioration and torque decrease and the like due to notches formed in the core are able to be prevented.

Also, when flat wire coils in particular are used for the cassette coils 41, a large repulsion force (spring back force) of the cassette coils 41 is generated. In this example embodiment, the wedges 51 are retained by the insulators 61 in positions facing the coil end portions 42, so the cassette coils 41 are able to be more reliably fixed while resisting this spring back force.

The spring back force of the cassette coils 41 tends to be larger on the lead side than on the anti-lead side of the stator core 31. In response to this, the pawl portions 66 of the insulators 61 provided on the lead side of the stator core 31 may be made thicker than the pawl portions 67 on the anti-lead side to increase the rigidity of the contact surface between the pawl portions 66 and the wedges 51.

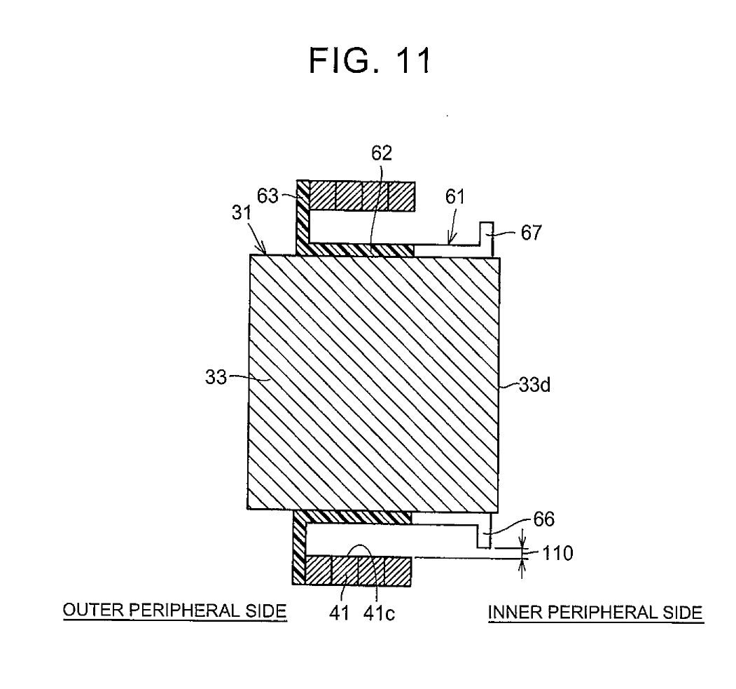

FIG. 10 is a view showing a frame format of the stator viewed from the direction indicated by arrow X in FIG. 4. In the drawing, the stator is shown in a state before the wedges 51 have been assembled. FIG. 11 is a sectional view of the stator taken along line XI-XI in FIG. 10.

Referring to FIGS. 10 and 11, when the tip ends of the teeth 33 that extend in the radial direction of the stator core 31 are viewed squarely (i.e., from an outside in the radial direction of the stator core), the pawl portions 67 and the pawl portions 66 are provided positioned in an area to the inside of the cassette coil 41 (i.e., an area farther to the inside than an inner peripheral surface 41c of the cassette coil 41). According to this structure, an insertion gap 110 of the cassette coils 41 in which the insulators 61 is inserted is ensured, so workability during assembly of the cassette coils 41 is able to be improved.

The pawl portions 67 and the pawl portions 66 are provided not protruding radially inward of the stator core 31 from tip ends 33d of the teeth 33.

Now the structure of the motor-generator 10 as a rotary electric machine according to the example embodiment of the invention described above will be summarized. The motor-generator 10 of the example embodiment includes the cylindrical stator core 31 that has the plurality of teeth 33 arranged spaced apart from each other in the circumferential direction, which extend in the radial direction, the cassette coils 41 that are arranged on the outer periphery of the teeth 33, the insulators 61 that have the pawl portions 66 and 67 and are interposed between the stator core 31 and the cassette coils 41, and the wedges 51 as fixing members that are provided extending between the cassette coils 41 that are adjacent to each other, and which fix the cassette coils 41 to the stator core 31. The wedges 51 are retained by the pawl portions 66 and 67 of the insulators 61 that are adjacent to each other.

According to the motor-generator 10 of the example embodiment of the invention structured in this way, torque decrease and magnetic loss are able to be inhibited by retaining the wedges 51 by the insulators 61. At this time, inhibiting a torque decrease makes it possible to reduce costs by reducing the layering thickness of the magnetic steel sheets, and the mounting space of the motor-generator 10 is able to be kept small through size reduction achieved by reducing the core axial length. Also, inhibiting magnetic loss enables motor loss to be reduced, which in turn enables fuel efficiency of the vehicle to be improved.

In this example embodiment, a structure in which the protruding portions 54 and the hooked portions 55 of the wedges 51 are inserted in between the cassette coils 41 and the pawl portions 66 and 67 of the insulators 61, is described as the retaining structure of the wedges 51, but the retaining structure of the wedges 51 is not limited to this. For example, a structure in which a protruding portion provided on the wedges 51 is fitted into a groove or recessed portion formed in the insulators 61 may also be employed.

Further, the direction in which the wedges 51 are assembled to the stator core 31 is not limited to the axial direction of the stator core 31. For example, the wedges 51 may also be assembled to the stator core 31 in the radial direction of the stator core 31. Also, a coil wire that forms the cassette coils 41 is not limited to a flat wire multi-layered winding coil. That is, the coil wire may also be a round wire coil. Moreover, the material that forms the wedges 51 is not particularly limited as long as it is material that has an insulating function. For example, the material may also be resin that includes magnetic powder, or paper-like material (effective for reducing torque pulsations).

The example embodiments disclosed herein are in all respects merely examples and should in no way be construed as limiting. The scope of the invention is indicated not by the foregoing description but by the scope of the claims for patent, and is intended to include all modifications that are within the scope and meanings equivalent to the scope of the claims for patent.

The invention is mainly used in the manufacturing industry of electric motors.

What is claimed is:

1. A rotary electric machine comprising:
a cylindrical stator core having a plurality of teeth that are arranged spaced apart from each other in a circumferential direction and extend in a radial direction;
a cassette coil arranged on an outer periphery of each of the teeth;
an insulator that has a retaining portion and is interposed between the stator core and the cassette coil; and
a fixing member that is provided extending between the cassette coils that are adjacent to each other, which fixes the cassette coils to the stator core,
wherein the fixing member is retained by the retaining portions of the insulators that are adjacent to each other.

2. The rotary electric machine according to claim 1, wherein when tip ends of the teeth that extend in the radial direction of the stator core are viewed from an outside in the radial direction of the stator core, the retaining portion is positioned in an area to an inside of the cassette coil.

3. The rotary electric machine according to claim 1, wherein
the cassette coil has a coil end portion positioned on an end surface of the stator core; and
the fixing member is retained by the retaining portion in a position facing the coil end portion.

4. The rotary electric machine according to claim 1, wherein the cassette coil is formed by a flat wire multi-layered winding coil.

5. The rotary electric machine according to claim 1, wherein
the fixing member includes
a pressing portion that extends between the cassette coils that are adjacent to each other and extends in an axial direction of the stator core while abutting against the cassette coils; and
an engaging portion that is provided on an end portion of the pressing portion in an extending direction thereof, and is engaged by the retaining portion.

6. The rotary electric machine according to claim 5, wherein
the retaining portion has a pawl shape that is arranged farther toward a radially inward side of the stator core than the cassette coil; and
the engaging portion is inserted between the cassette coil and the retaining portion.
